(19) United States
(12) Patent Application Publication
(10) Pub. No.: US 2025/0383107 A1
(43) Pub. Date: Dec. 18, 2025

(54) SELECTIVELY PET ACCESSIBLE HUMAN-PET CO-SEATING

(71) Applicant: SeatMate Intellectual Properties, Dover, DE (US)

(72) Inventors: Andrew Joseph Mueller, Dallas, TX (US); Jacob Hillis Singer, Portland, OR (US); Ryan Joseph O'Malley, La Grange Park, IL (US)

(21) Appl. No.: 19/323,262

(22) Filed: Sep. 9, 2025

Related U.S. Application Data
(62) Division of application No. 18/667,516, filed on May 17, 2024.

(51) Int. Cl. F24F 11/39; F24F 8/108; F24F 11/63; F24F 110/64; F24F 110/65

(52) U.S. Cl. CPC F24F 11/39; F24F 8/108; F24F 11/63; F24F 2110/64; F24F 2110/65

(57) ABSTRACT

The present invention comprises a variety of embodiments which all provide an apparatus, either standalone or attached to a piece of furniture, that enables a pet to sit or lay down next to its owner, and includes safe and accommodating ascending and descending structures for the pet's mobility and comfort.

### CROSS-REFERENCE TO RELATED APPLICATIONS

The subject matter of this application may have common inventorship with and/or may be related to the subject matter of the following:
U.S. Provisional Application Ser. No. 63/502,852, titled “Selectively Pet Accessible Human-Pet Co-Seating,” filed by Andrew Mueller, on May 17, 2023.
U.S. Provisional Application Ser. No. 63/582,721, titled “Selectively Pet Accessible Human-Pet Co-Seating,” filed by Andrew Mueller, on Sep. 14, 2023.
U.S. Provisional Application Ser. No. 63/600,501, titled “Selectively Pet Accessible Human-Pet Co-Seating,” filed by Andrew Mueller, on Nov. 17, 2023.
U.S. Provisional Application Ser. No. 63/625,158, titled “Selectively Pet Accessible Human-Pet Co-Seating,” filed by Andrew Mueller, on Jan. 25, 2024.
U.S. Non-provisional application Ser. No. 18/667,516, titled “Selectively Pet Accessible Human-Pet Co-Seating,” filed by Andrew Mueller, on May 17, 2024.

This application incorporates the entire contents of the foregoing applications herein by reference.

### FIELD OF INVENTION

The present invention generally relates to pet seats. More specifically, the present invention relates to human-pet co-seating apparatuses.

### BACKGROUND OF THE INVENTION

Pet owners generally enjoy being close to their pets. Likewise, pets generally enjoy being close to their owners. Working from home has been an ever-growing sector of occupations since before (but exponentially grown by) the 2020 pandemic. This trend has created the opportunity for pets and owners to spend more time close to one another, but this often assumes the form of pet bedding being placed on the floor, the pet laying either on the owner's desk, in their lap, or on the floor, or the pet distracting the owner from their occupational duties.

Pet furniture is typically designed for pets to have a mat to lay on or some small, elevated spot inches off the floor with a cushion. Anything requiring more than a small step up can become a problem for many pets. Moreover, pet mobility is a common issue for many pet owners and may be caused by the pet's small stature, the pet's age, or the pet's health condition. Pet-focused ramps and stairs are some solutions for these mobility concerns; however, they can be cumbersome and take up quite a lot of space.

There exists a need for a seating apparatus designed for pets that brings pets closer to their owners without necessarily hindering their owner's work. Further, it would be beneficial if such an apparatus were coupled to the owner's office chair or other furniture to allow the apparatus to move as the owner moved in their workspace. Even further, it is greatly beneficial and enabling to provide some sort of method for pets to easily access the seating area next to their owners (without their owner's lifting the pet or the pet having to jump/climb 1.5-3 feet high). Finally, there exists a need for this apparatus and method of pet access to be engaged and disengaged so that the apparatus does not take up too much room and may be easily stored.

### SUMMARY OF THE INVENTION

The following presents a simplified summary of the present invention to provide a basic understanding of the invention's concepts. This summary is not an extensive overview, and it is not intended to identify critical elements or to limit the scope of this disclosure. The sole purpose of this summary is to present some general concepts in a simplified form as a prelude to the detailed description of the invention.

The subject matter disclosed and claimed herein, in some embodiments of the present invention, relates to a standalone pet seating apparatus comprising a frame having a front, a back, and two sides; a pet seat attached to the frame; an elevation piece attached to the front of the frame and designed to be positioned in an engaged position and a disengaged position by a user to allow a pet to easily access the seat at the user's desire, and the elevation piece including a walking surface for the pet to traverse; a securing mechanism to secure the elevation piece in at least one of the engaged position and disengaged position; and the standalone pet seating apparatus being constructed for the elevation piece to be stored under the pet seat when in the disengaged position.

The subject matter disclosed and claimed herein, in some embodiments of the present invention, relates to a human-pet co-seating apparatus comprising: a frame having a front, a back, and two sides; a human seat attached near one side of the frame; a pet seat attached near the other side of the frame; and an elevation piece attached to the front of the frame and designed to be positioned in an engaged position and a disengaged position by a user to allow a pet to easily access the pet seat at the user's desire, and the elevation piece including a walking surface for the pet to traverse; a securing mechanism to secure the elevation piece in at least one of the engaged position and disengaged position; and the human-pet co-seating apparatus being constructed for the elevation piece to be stored under at least one of the human seat and the pet seat when in the disengaged position.

The subject matter disclosed and claimed herein, in some embodiments of the present invention, relates to A human-pet co-seating apparatus comprising: a frame having a front, a back, and two sides; a sidecar pet seat attached to the frame; a sidecar attachment mechanism attached to the frame and designed to attach the sidecar pet seat to a chair made for at least one human to sit in; an elevation piece attached to the front of the frame and designed to be positioned in an engaged position and a disengaged position by a user to allow a pet to easily access the seat at the user's desire, and the elevation piece including a walking surface for the pet to traverse; a securing mechanism to secure the elevation piece in at least one of the engaged position and disengaged position; and the human-pet co-seating apparatus constructed for the elevation piece to be stored under the sidecar pet seat when in the disengaged position.

To the accomplishment of is foregoing and related ends, certain illustrative aspects of the disclosed innovation are described herein in connection with the following description and the annexed drawings. These aspects are indicative of only a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The embodiments of the present invention disclosed herein are illustrated by way of example, and not by way of limitation, in the figures of the accompanying drawings, in which like reference numerals may refer to similar elements.

FIGS. 1A-1C depicts an exemplary embodiment of a standalone pet seating apparatus from a variety of angles.

FIGS. 2A-2E depict an exemplary engagement of one embodiment of the elevation piece of the present invention.

FIGS. 3A and 3B depict an embodiment of a human-pet co-seating apparatus resembling a bench.

FIGS. 4A-4C depicts a pet seating apparatus that is attached to an office chair.

FIGS. 5A-5D provide another exemplary embodiment of the present invention featuring a sidecar that may act as a standalone pet seating apparatus.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

Pets are often considered analogous to children by many owners. Particularly owners who are of a generation of people with a declined birthrate of children. This connection between owner and pet is reinforced like most human connection, through closeness and time spent together. Therefore, there is a need for human-pet co-seating apparatuses or at least apparatuses that allow the pet to participate in the owner's life and activities. That said, there is no one-size-fits-all apparatus in this field, literally, because not all pets are the same size or weight. Therefore, the present invention may be thought to have multiple embodiments as to accommodate pets of different sizes and mobility.

Additionally, not every apparatus will satisfy the needs of every owner. Therefore, having the flexibility between standalone apparatus or those that couple with already existing furniture (such as an office chair) is very desirable. This ability to convert between an attached version and a standalone version of the pet seating apparatus will be found particularly beneficial by many owners. Further, the ability for a structure that aids the pet to reach the seat of the apparatus also does not have a one-size-fits-all solution. Thus, having a structure be adjustable or settable within a plurality of positions is desired by some owners. Finally, because pet ramps, pet steps, and other elevation means can be cumbersome and take up large amounts of space, there is a need for a storable solution to such elevation means.

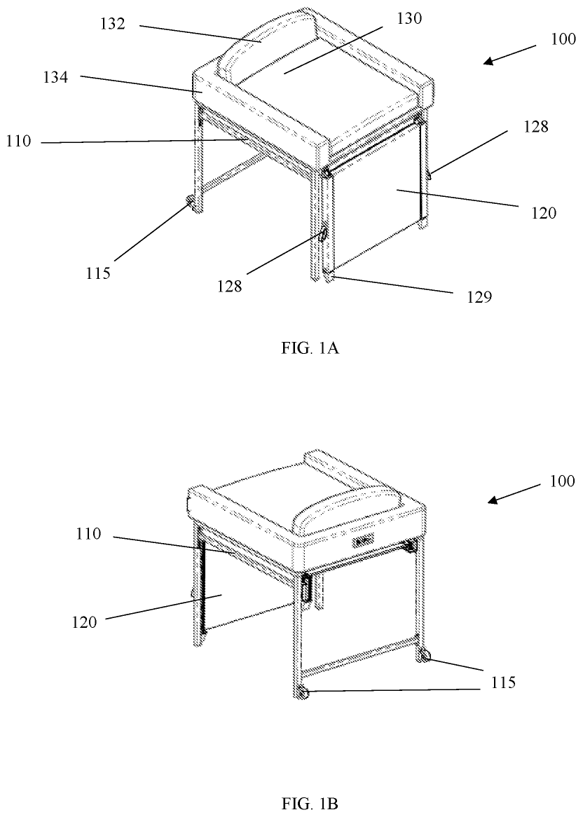

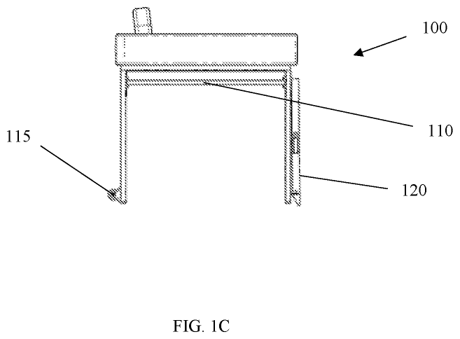

FIGS. 1A-1C depicts an exemplary embodiment of a standalone pet seating apparatus from a variety of angles. The depicted embodiment of a standalone pet seating apparatus 100 includes a frame 110 which may have wheels 115, an elevation piece 120, a securing mechanism 128, stability pieces 129, a seat 130, a backpiece 132, and a seat support structure 134. The frame 110 may be made out of lightweight yet durable materials such as metal, wood, plastic, and the like. The frame should be constructed to sufficiently support the weight of the desired size of pet which may use the standalone pet seating apparatus 100. For example, smaller pets such as cats or dogs of smaller breeds such as Pomeranians, Shih-Tzus, Chihuahuas, Pugs, Maltese, Jack Russell Terriers, etc. (up to about 25 pounds) may allow for a much lighter weight frame due to the pet's lite weight and lack of strength. However, medium to larger breeds of dogs such as Pembroke Welsh Corgis, Shiba Inus, Beagles, Border Collies, Poodles, and the like (about 25 to about 50 pounds) may require the frame 110 to be made of slightly more durable and sturdy material because these pets not only weight more but may cause more strain on the frame by their energetic movements. Even further, a standalone pet seating apparatus 100 may be constructed for larger breed dogs (over about 50 pounds) and these versions of the present invention would call for the frame 110 to be made of strong and durable materials as well as, potentially, additional support structures, such as brackets, being added to strengthen the stability of the frame 110 and increase its weight capacity. Regardless of the size of the pet and the appropriate frame to be desired, it should be understood that construction of the frame 110 should account for more than just the pet's weight because pets do not take the care that humans do when using furniture. The frame 110 may have a front opposite to a back and include two sides (such as left and right), with the front aligning to the position on the frame 110 wherein the elevation piece 120 couples to the frame 110 and the back aligning with the position of the backpiece 132.

The frame 110 may further include wheels 115, such as caster wheels, which allow a user to tilt the standalone pet seating apparatus 100 back (using the “back” legs of the frame) so that the wheels engage with the underlying surface or floor. Then, the user may easily roll the standalone pet seating apparatus 100 with the aid of the wheels 115 to the user's desired location. Ideally, these wheels 115 do not engage with the surface or floor while the standalone pet seating apparatus 100 is upright, in its set position, ready to be used by the pet (as shown in FIG. 1C). This prevents the pet's movements and/or force from undesirably moving the standalone pet seating apparatus 100.

In some embodiments, the elevation piece 120 may be in the form of a foldable ramp. The ramp should be constructed in such a way that at least part of it is housed beneath the seat 130 and within or not far beyond the boundaries of the frame 110. Further, the frame 110 may be adapted to house the mechanism which allows the elevation piece 120 to engage and disengage. Further, the frame 110 may be adapted to conceal part or all of the mechanism(s) to engage and disengage the elevation piece 120 for aesthetic and/or safety purposes.

In alternative embodiments, the elevation piece 120 may be in different forms of elevation structures, such as a step or stairs. These stairs may be selectively deployable, storable, and/or retractable with a simple mechanism(s) such as railings, brackets, sequenced railings or brackets, a pivot, and so forth. Regardless of the style of elevation piece 120, it is most convenient that most or all of the elevation piece 120 remain mostly concealed when the elevation piece 120 is disengaged.

The elevation piece 120, in some embodiments, includes the securing mechanism 128 which prevents the elevation piece 120 from undesirably disengaging from a counterpart to the securing mechanism, structure, or receiver located in the frame 110. The counterpart mechanism, structure, or receiver may engage with the securing mechanism 128 to secure the elevation piece 120 in its disengaged, stored, or “put away” position. The securing mechanism 128 may further be adapted to also lock the elevation piece in its engaged position and/or intermediate (i.e. partially engaged) positions.

In some embodiments, the receiver for the securing mechanism 128 may be a rail that the elevation piece 120 is coupled to beneath the seat 130. The rail may have a track that is along either or both sides of the frame 110 and be coupled front-to-back with the standalone pet seating apparatus 100 (with “back” corresponding to the side having the backpiece 132). This may be called a slanted rail system. A counterpart piece to the rail (for example a wheel or bearing or other coupled piece) serves as the securing mechanism 128 for the elevation piece 120. In further embodiments, the rail may be angled such that the end of the rail near the back of the frame 110 is lower (closer to the ground) than the end of the rail near the front of the frame 110. As such, when the elevation piece 120 is put away or disengaged, the weight of the elevation piece coupled to the rail and beneath the seat 130 (or otherwise housed within the frame 110) retains enough force due to gravity to prevent the elevation piece 120 from undesirably engaging.

The elevation piece 120 may further include stability pieces 129 that are attached and designed to compliment the angle created between the elevation piece 120 in its engaged position and the surface or floor. Put another way, if the top of the elevation piece 120 is near the seat 130 and the bottom of the elevation piece 120 is near the floor or surface, the stability pieces 129 are attached to the bottom of the elevation piece 120. These pieces may be made of materials such as rubber or harder silicone which will not damage any surface or floor while also providing some measure of grip and stability to ensure that the elevation piece 120 does not undesirably move, fold, or disengage when used by the pet.

In further embodiments, the elevation piece 120 may be constructed to allow all or part of its ramp or stairs to rotate or swivel about an axis as to allow the pet to enter the seat 130 from more than the straightforward angle ahead of the front of the frame 110. These embodiments may include pieces that supply more walking area (or additional platforms in the case of stairs) for the pet as a portion of the elevation piece 120 is swiveled or rotated about the axis. The elevation piece 120 may include mechanisms to restrict the rotation of the elevation piece 120 to only allow the elevation piece 120 to rotate to angles within desired bounds and at desired positions. The ramp or stairs may be foldable to allow for better storage when disengaged or to supply a plurality of angles and/or lengths of said ramp or stairs.

The seat 130 is the only required component between the seat 130, the backpiece 132, and the seat support structure 134 in the most basic embodiments of the present invention. However, many users and their animals/pets will appreciate embodiments having the sides and back support for the pet to lean on or lay down against, better allowing the pet to rest and relax.

The seat 130, the backpiece 132, and the seat support structure 134 may be made of the same or different materials from one another. These three components are ideally made of pet-friendly materials including canvas, denim, certain leathers or pleathers, ultrasuede, outdoor fabrics, and microfiber materials, and combinations thereof, although any material that is easily cleaned and resistant to damage from pet's claws or teeth are most desired when constructing the standalone pet seating apparatus 100. Regardless of material(s) used, animal and human safe treatments or coatings may be applied to the materials as to resist odor, moisture damage, liquid absorption, dirt, and other pet-related issues for furniture. Further, slipcovers or other protective products may be placed around any or all of the seat 130, the backpiece 132, and the seat support structure 134.

In some embodiments, the seat 130 will primarily include a base that rests on or is affixed to the frame 110, cushion or padding, and an exterior material (which may or may not cover the base of the seat 130). The cushion or padding may be made from typical pet furniture cushioning or padding materials such as viscoelastic polyurethane foam, low-resilience polyurethane foam, down, feathers, batting, polyester, other foams of varying density and elasticity, and so forth. Some embodiments may include common furniture construction including planks, slats, and/or springs to support the weight of the pet. The exterior material may be made of the previously mentioned pet-friendly materials.

The backpiece 132 may rest upon the seat 130 or attach to the seat 130, the frame 110, or the seat support structure 134. It will usually be constructed similarly to the seat in that it will have a backpiece base, cushioning or padding, and exterior material.

The seat support structure 134 may attach or rest upon the frame 110. Further, the seat support structure 134 may include a support base with receiving portions for coupling with the seat and/or the seat support structure 134 may merely rest on or around the seat to provide the equivalent of chair arms or a barrier so that the pet using the seat 130 does not fall or roll of the sides of the seat 130. The combination of the backpiece 132 and the seat support structure 134 should encourage the pet to only descend from the standalone pet seating apparatus 100 down the elevation piece 120. Of course, pets being animals, the pet may still choose to jump over the backpiece 132 or seat support structure 134 in lieu of using the elevation piece 120. Some constructions of the present invention may include backpieces and seat support structures made to disallow such unwanted dismounting by the pet, such as constructions having very high walls.

Any combination or none of the seat 130, the backpiece 132, and the seat support structure 134 may couple with the frame 110. The ability to decouple said components is desirable when cleaning, repairing, or replacing the exterior materials which is likely to be necessary more often for pet furniture than with human furniture. As such, easily coupling and decoupling mechanisms such as hole and pin (with or without retainers or clips), slide locking structures or rails, snaps, fasteners, and the like are desirable for consumer-focused embodiments of the present invention.

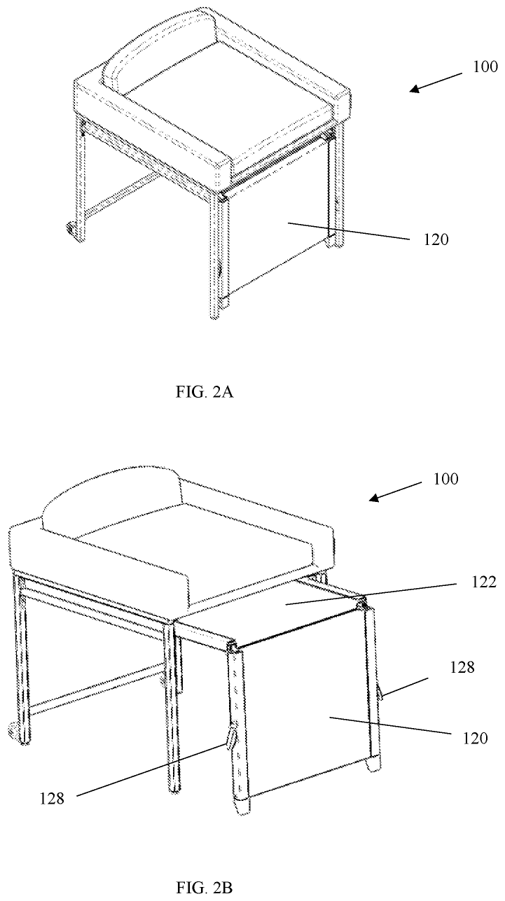

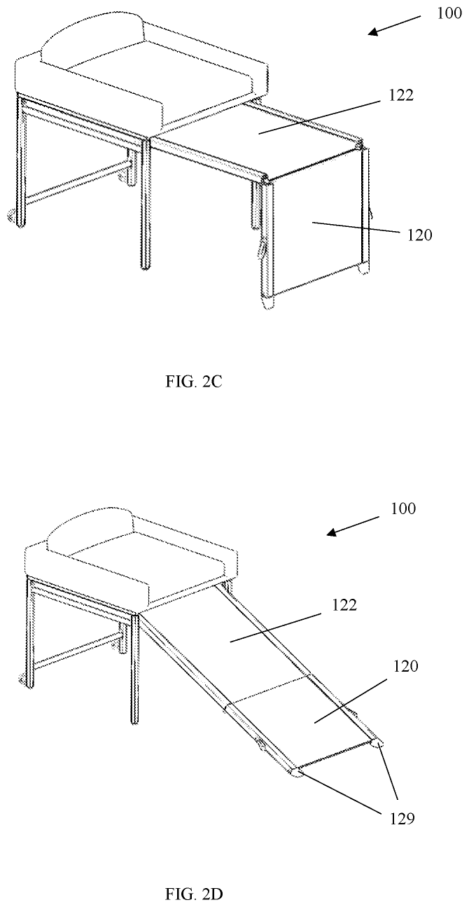

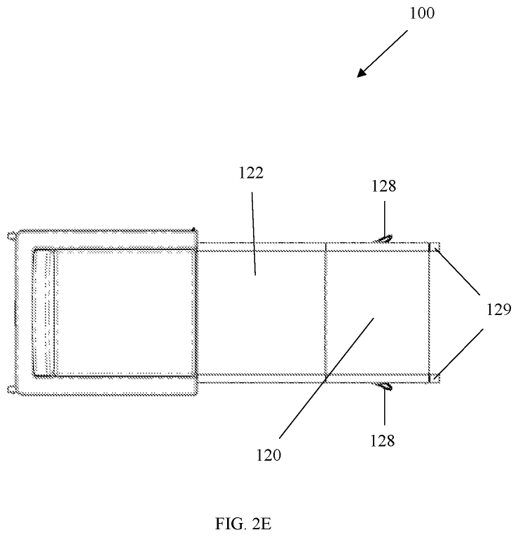

FIGS. 2A-2E depict an exemplary engagement of one embodiment of the elevation piece of the present invention. In these figures, we can see the disengaged elevation piece 120 (FIG. 2A) extended outwards from the front of the standalone pet seating apparatus 100 by sliding along (in this embodiment) a guided rail system (FIGS. 2B and 2C) and revealing an extension piece 122. The extension piece 122 is part of the elevation piece 120. Once the extension piece 122 reaches the end of its outward track, it may hingedly orient with the guided rail system attached to the frame 110 and the elevation piece 120 to create an evenly sloped ramp (FIG. 2D). In some embodiments, the extension piece 122 is part of the elevation piece 120. The extension piece 122 and the elevation piece 120 may have a plane locking mechanism which prevents the two pieces from undesirably folding once they have created a singular plane or slope. Another securing mechanism may prevent the extension piece from changing its angle created between it and the guide rail system attached to the frame 110; however, this mechanism may be unnecessary as the angle of the slope and the weight of the pet using the ramp should apply enough downward pressure to prevent any movement about the pivot created between the extension piece 122 and the guided rail system. As previously described, the weight of the extension piece 122 coupled with a slanted rail system, wherein the back of the rail is closer to the ground, desirably creates a securing mechanism 128 that operates without a clip, peg, or button. Put another way, the elevation piece 120 may be held in the disengaged or engaged positions by its weight and the force of gravity. Even further, the slanted rail system may include curved dips that allow the counterpart piece on the extension piece 122 or elevation piece 120 (such as a wheel or bearing) to sit in those dips to provide some additional resistance to changing positions (due to gravity and the curvature of the dips).

In alternative embodiments, the elevation piece 120 may have a different method of providing the pet with a way to reach the seat 130 of the standalone pet seating apparatus 100 (instead of the extension piece 122) such as hidden steps or other pet-friendly methods of walking or climbing up the roughly one-to-three vertical distance between the floor and the seat 130.

In some embodiments the elevation piece 120 and the extension piece 122 may include a walking surface (such as carpet, fabric, supertraX, sandpaper-like, or other textured or non-slip material(s)) to allow the pet to ascend and descend (or otherwise traverse) the elevation piece 120 without slipping, stumbling, falling, etc.

FIG. 2E shows a top-down view of one embodiment of the present invention. This depiction shows the spring-loaded securing mechanisms 128 slightly protruding from the frame. These securing mechanisms 128 should be designed such that they retract when the elevation piece 120 is being disengaged and stored aligned the frame 110 in a closed position. The securing mechanisms 128 would protrude again once they are positioned within complimentary receiving structures within the frame 110 when the elevation piece 120 is fully disengaged. The stability pieces 1129 are also prominently shown and it can be seen that they extend slightly further than the base of the elevation piece 120 (the portion that contacts with the surface or floor) to allow them to grip adequate surface area to accomplish their described purpose.

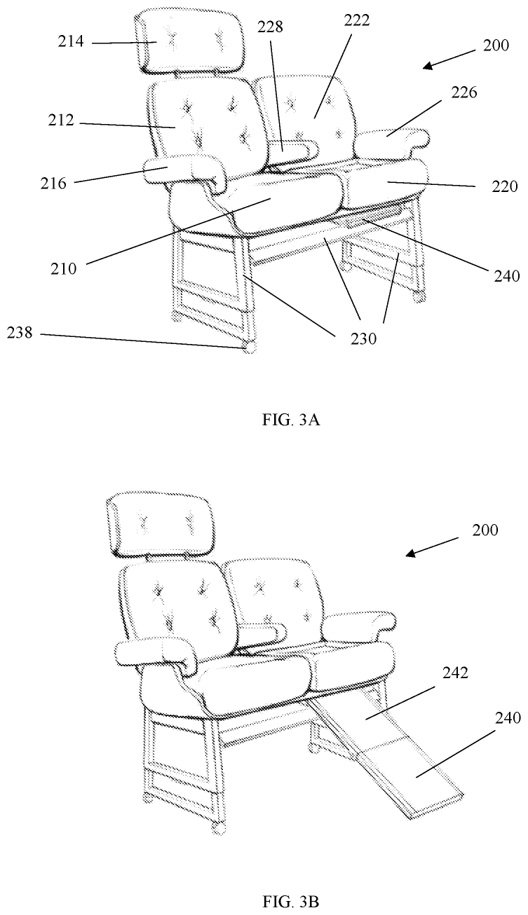

FIGS. 3A and 3B depict an embodiment of a human-pet co-seating apparatus resembling a bench. In some embodiments, a human-pet co-seating apparatus 200 (or merely seating apparatus) includes a human (or first) seat 210 (or merely seat), a first backpiece 212, a headrest 214, a first arm 216, a pet (or second) seat 220, a second backpiece 222, a second arm 226, an intermediate arm 228, a frame 230 which may have wheels 238, and an elevation piece 240. The seating apparatus 200 may be made, generally, of the same materials as the standalone pet seating apparatus 100, that is to say, metals, plastics, rubbers, fabrics, canvas, etc. It should he considered that the seating apparatus 200 depicted in FIGS. 3A and 3B primarily forms a bench which will support the weight of at least one person as well as at least one pet; therefore, material selection and construction of the seating apparatus 200 should ensure that certain weight limits are considered and that animals typically apply more weight than a person would when getting on, moving around on, or getting off the seating apparatus 200. Put another way, this version of the seating apparatus 200 depicting a bench should be of sturdy construction and have, ideally, no wobble as the movements of an animal would make it more likely for the seating apparatus 200 to topple.

The seat 210 may include the first backpiece 212, the headrest 214, and the first arm 216, or they may be optional components. Regardless, for aesthetic and manufacturing reasons, these pieces will likely all be made of the same materials, which, again, like the standalone pet seating apparatus 100, should include human and animal-conscious materials that are durable and easy to clean. In some embodiments, the seat 210 may include a cushion that is removable for easy cleaning. Further, the seat 210 and the pet seat 220 may be different than one another. For example, the pet seat 220 will likely have smaller dimensions than the seat 210 because the pet is likely to take up less space. For example, if a pet owner wished to sit by their small-breed dog, the small breed dog would require much less space and if the two seats (the seat 210 and the pet seat 220) were of the same size and dimensions, then the pet may not be as adequately accommodated as desired. For example, the pet seat 220 may include a recessed area which better allows the pet to reach a more desirable orientation (such as the common “donut” position that dogs take where they slightly curve their bodies). The recessed area may also act as a small barrier to prevent the pet from rolling off the pet seat 220 while sleeping or moving around, potentially injuring itself.

Likewise, the second backpiece 222 and the second arm 226 are optional components of the pet seat 220; however, desired embodiments include them.

The intermediate arm 228 is another optional component that may be moveable about a pivot so that it has an “up” and a “down” positions (the depicted embodiment shows the down position). In the up position, the intermediate arm 228 should be stowed away, such as between the first backpiece 212 and the second backpiece 222. This allows the pet owner to place a deterrent or barrier between themself and the pet, if desired. It may also provide benefits to the pet, such as function as a headrest for the pet instead of an armrest for the human.

The frame 230 should be constructed to adequately support the weight of the seat 210, the pet seat 220, the human, the pet, and allow for other considerations. The frame 230 may include wheels 238 to allow the seating apparatus 200 to be easily moved by one person. This may be necessary because of the materials used in the seating apparatus's 200 construction as well as the userbase which may include those with less strength. These wheels 239 may include wheel locking mechanisms so that the wheels do not undesirably move while the seating apparatus 200 is in use or when a pet or human sits on or gets off the seating apparatus 200. Caster wheels, with a swivel and wheel locking mechanism, are particularly useful in some embodiments of the present invention due to their benefits along with their economic advantages.

The seating apparatus 200 includes an elevation piece 240 which may be of the same type or a different type than that described in FIGS. 1A-2E. In some embodiments, the elevation piece 240 may include an extension piece 242 which is revealed when the elevation piece 240 is engaged to allow the pet to easily access the pet seat 220. As described in the previous embodiment with the standalone pet seating apparatus 100, the elevation piece 240 and the extension piece 242 may include securing mechanisms to prevent the formed ramp from undesirably folding at the intersection between the elevation piece 240 and the extension piece 242, and the extension piece 242 and the frame 230. Further, as noted in a previous embodiment, the frame 230 may include a guide rail system so that the extension piece is securing housed beneath the pet seat 220 when the elevation piece 240 is disengaged. Though not depicted, it should be understood that the ramp comprising the elevation piece 240 and extension piece 242 may also contain the previously mentioned securing mechanisms and stability pieces which provide the same, previously noted, benefits.

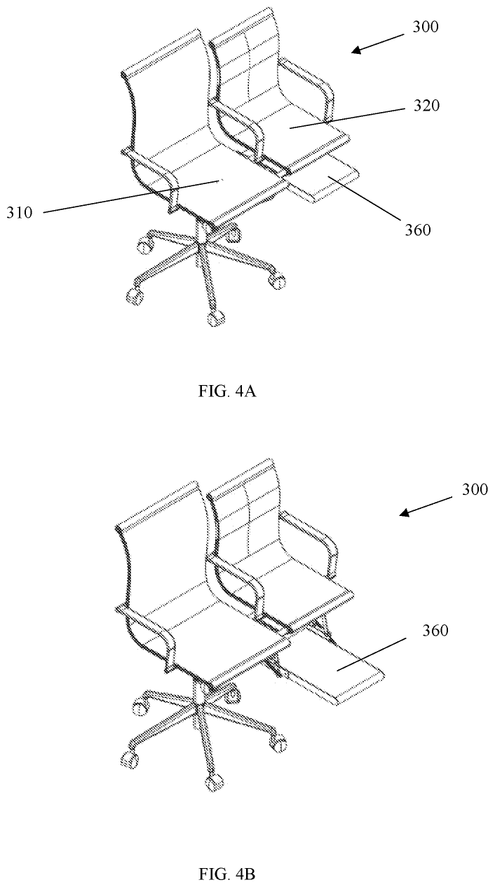

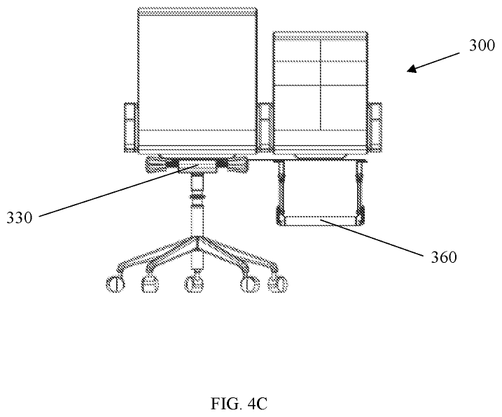

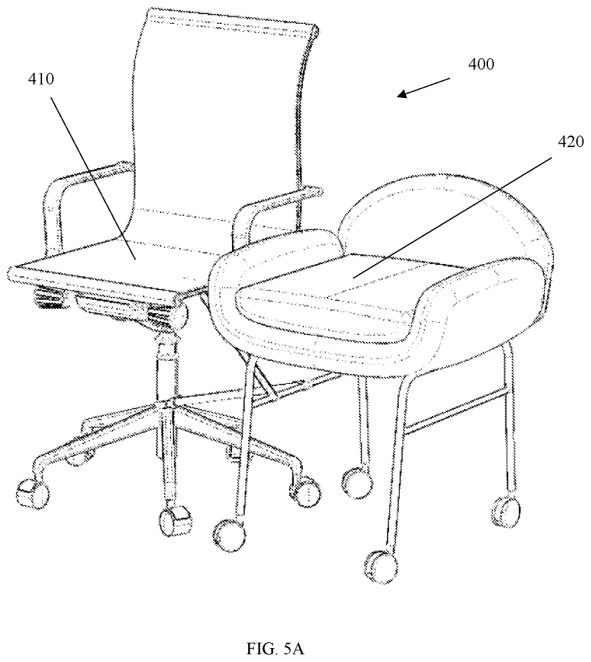

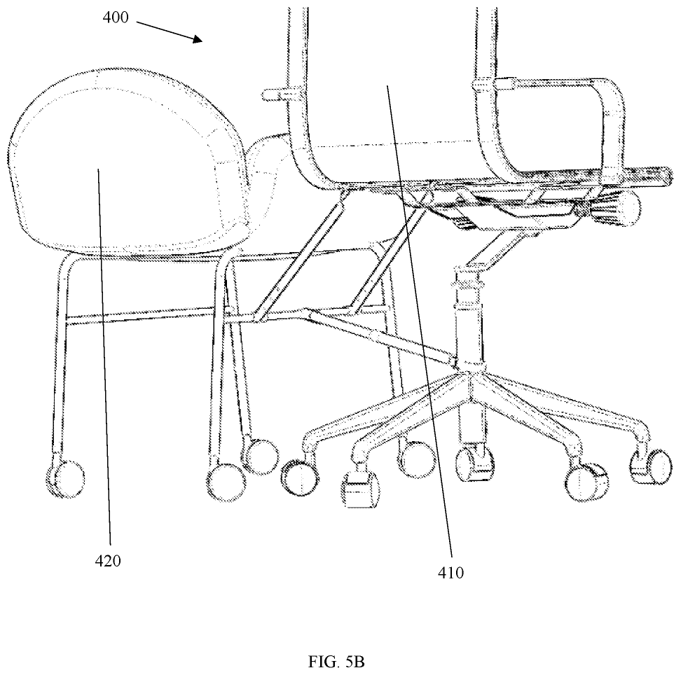

FIGS. 4A-4C depicts a pet seating apparatus that is attached to an office chair. In some embodiments, a human-pet co-seating apparatus 300 (or merely seating apparatus) includes an office chair 310 with an attached sidecar pet seat 320 (or sidecar) having an elevation piece 360. The office chair 310 may be other types of furniture; however, the intent is always that the furniture provides a seat for the human so that the human can sit by their animal/pet. Other types of chairs and even some couches and similar products may be adapted to couple with the sidecar 320. Alternatively, the sidecar 320 may be adapted to certain pieces or types of furniture. As such, FIG. 4C depicts a sidecar attachment mechanism 330 which has been adapted to attach to the office chair 310. The sidecar 320 will generally have smaller dimensions than the office chair 310 because most pets are smaller than the human sitting beside them. Further, we use an office chair as example but the sidecar 320 could be designed to couple to any chair made for at least one human to sit in.

The sidecar 320 may include a frame which may or may not include legs that reach the floor or surface. Frames including legs may also include caster wheels (or similar structures to prevent the legs of the frame from scratching the floor or surface) at the end of the frame, contacting the floor or surface. The frame and caster wheels should not contact the base, legs, shaft, or other part of the office chair 310 as the office chair 310 moves or rotates/swivels. In some embodiments, the frame may have a front, a back, and two sides; form a support structure for the seat of the sidecar 320; and couple to the sidecar attachment mechanism 330 (providing an intermediary between the seat of the sidecar 320 and the sidecar attachment mechanism 330).

This sidecar attachment mechanism 330 may include a counterweight to prevent the weight of the sidecar 320 from tipping the office chair 310 over. This may be necessary because the added weight of the sidecar 320 may cause the center of gravity of the “combined” seating apparatus 300 to skew towards the sidecar 320, tipping the office chair 31 over. This counterweight may not be necessary as the weight of the human should already provide sufficient counterweight to the weight of the sidecar 320 plus the weight of the pet. The counterweight would be most useful in the instance that the pet uses the sidecar 320 without the presence of the human sitting in the office chair 310. Further, the counterweight may be necessary for embodiments of the present invention adapted to allow heavier pets to sit in the sidecar 320 and to accommodate to those pets' entry, exit, and movement about the sidecar 320. The sidecar attachment mechanism 330 may include brackets, bolts or screws to couple to receivers on the office char 310, clamps, and other supports that (1) ensure the sidecar 320 will not undesirably detach from or rotate around the office chair 310 during use, (2) that the sidecar attachment mechanism 330 (particularly the connecting bar or structure between the base of the office chair 310 and the base of the sidecar 320) does not deform due to the weight and/or movement of the pet, (3) help stabilize and support the seating apparatus 300, and (4) ensure that the sidecar attachment mechanism 330 may be attachable to a variety of chairs and furniture of different heights and sizes, distances to an attachment point on the chair or furniture, sizes of the seat of the chair or furniture, seat heights, and so forth. The attachment point of the chair or furniture is merely where the sidecar attachment mechanism couples to on the chair or furniture, and may include special structures such as receiving brackets, gaskets, or other structures to ensure a secure attachment for the sidecar 320.

In some embodiments, the sidecar 320 may attach to the office chair 310 at multiple points including at least two of: their respective bases, a shared chair arm, a support structure under the bases, a support structure along their backs, and between their seats.

It should be understood that the depicted office chair 310 includes a single beam attached to the seat and leading to a five-pronged wheelbase having caster wheels, but other office chairs would still work as the present invention including chairs with four legs.

In some embodiments, the elevation piece 360 may be in the form of a step or set of steps including swing-out steps, retractable steps, manual steps, folding steps, extendable steps, pull-out spring-loaded steps, drop down steps, or other type of steps that are able to be engaged and disengaged. Regardless of form, these steps should be made of sturdy materials such as metal or hard plastics, and have a material (such as carpet, canvas, and the other previously listed materials) on top of them to aid the pet's climb into and out of the sidecar 320. The elevation piece 360 may lock into desired positions to allow for different angles created between the slope of the steps and the surface or floor under them. Further embodiments may include electrical components including gears, a motor, an actuator, a power source (such as a battery or power unit with cable for a wall socket), and a controller may be used to automate the engagement and disengagement of the steps as well as rotate/swivel the steps to a desired orientation. Even further embodiments may include a computer processor, memory, and settable desired positions for the elevation piece including its slope and if there is any rotation or swivel. This “powered” version of the elevation piece 360 will be particularly useful for humans who are young, elderly, or have an impairment or muscle weakness. In alternative embodiments, the elevation piece 360 may be of a combination of types of elevation pieces such as a set of steps having a small flap on the bottom step that extends like a ramp or bridge for the pet. The controller may be analogue or digital.

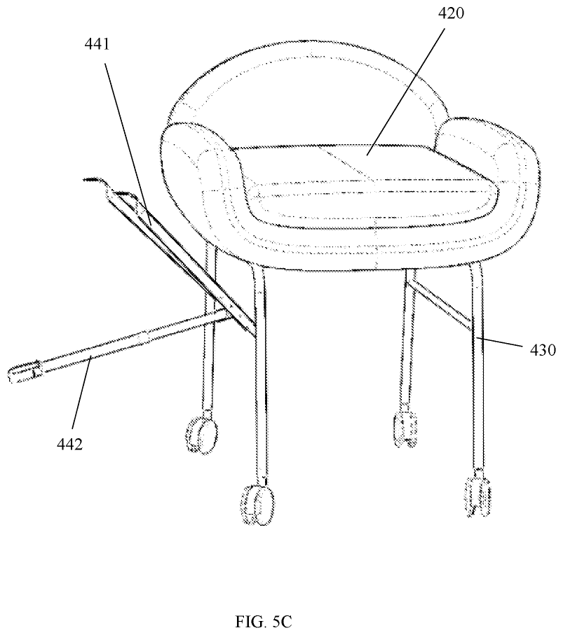

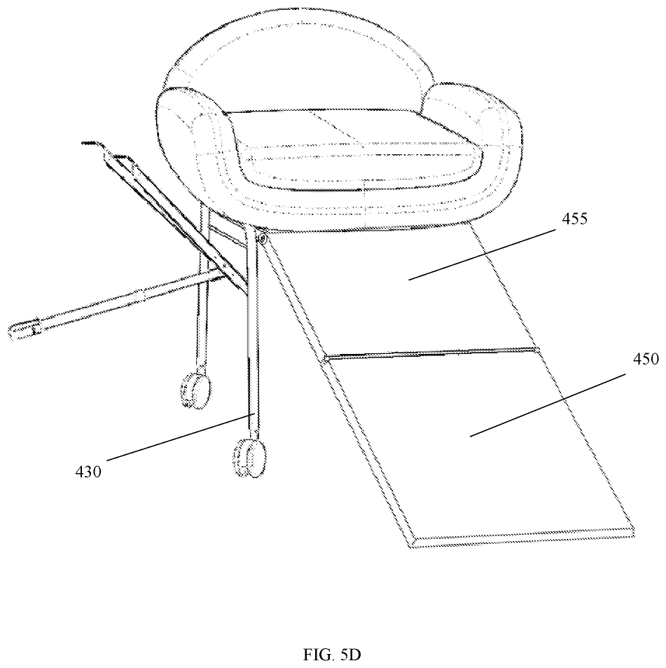

FIGS. 5A-5D provide another exemplary embodiment of the present invention featuring a sidecar that may act as a standalone pet seating apparatus. This embodiment is particularly useful because it allows the pet to use the present invention with or without it being attached to the human's seat. As such, if the pet enjoys using the seat, the human is not always required to be connected to the pet (because sometimes pets can be too clingy for some pet owners).

In the depicted embodiment of FIGS. 5A and 5B (which respectively show the front and the back of the present invention), an office chair 410 is coupled with an attached sidecar pet seat 420 (or sidecar) which may serve as a standalone pet seating apparatus while the sidecar 420 is detached from the office chair. Note that in FIG. 5D an elevation piece 450 and an extension piece 455 are shown to be part of the sidecar 420 and are attached to a frame 430. These components are not shown in FIGS. 5A-5C to allow for a better view of the other components of the present invention; however, it should be understood that this omission is merely for better view and description of the underlying structures and components.

FIG. 5C provides a more universal style of sidecar attachment mechanism having a top attachment means 441 and a bottom attachment means 442. Further, the bottom attachment means 442 and the top attachment means 441 may connect to an intermediate bar that is part of the frame 430 of the sidecar 420. The depicted embodiment provides a top attachment means 441 having two bars adapted to couple with the office chair 410 and a bottom attachment means 442 having a retainer adapted to encircle a portion of the shaft of the office chair 410. Again, the office chair 410 may be another type of chair or furniture in other embodiments.

Even further, the bottom attachment means 442, the top attachment means 441, or both may include telescoping shafts or extendable parts to accommodate attaching the sidecar 420 to a variety of different office chairs or furniture. In this embodiment, the top attachment means 441 may rest on the seat of the office chair, couple to a receiver attached to the office chair, or couple directly to the office chair (such as via fasteners like screws). Further, the bottom attachment means 442 may include a retainer to wrap around the shaft of the office chair.

It should also be noted that the depicted embodiment is adapted to attach to styles of office chairs having a shaft connecting a base of a seat of the office chair to a wheelbase. The sidecar attachment mechanism may be adapted to accommodate other types of chairs and furniture such as those having four legs.

The sidecar attachment mechanism may be adjustable to accommodate human chairs of different widths, sizes, and seat heights so that the human and pet sit on about the same level.

In some embodiments, the sidecar attachment mechanism may either detach from or be stored on the side of or beneath the frame 430 so that the sidecar be converted into a standalone pet seating apparatus or unit. It is important that the sidecar attachment mechanism not just sit out because it could cause a hazard within the home to a human or pet.

Even though the FIG. 5D depicts an embodiment of the elevation piece 450 in the form of a ramp, it should be understood that alternative elevation pieces (such as swing out steps, foldable steps, etc.) would also work just as well with the present invention. Further, the depicted ramp should be understood to be stored similarly to the explanation of the elevation piece of the standalone pet seating apparatus including aforementioned guide rail systems and securing mechanisms.

In alternative embodiments of any of the pet seating or human-pet co-seating apparatuses, the frames or area under the pet seats may be enclosed with walls and wherein at least one wall has an access panel (such as a door) so that the elevation mechanism may be hidden and/or storage space is provided under the seat. These walls may be made of the same materials used for the upholstery or other parts of the apparatuses or the walls may be made of more suitable materials such as thin particle board.

In further alternative embodiments, the pet seating apparatus may be multi-modal wherein the pet seat is hingedly attached to the frame and may be lifted to allow access to the elevation piece and for storage (similar to an ottoman).

Even though the pet seating apparatus and human-pet co-seating apparatus is intended in this disclosure for use by a human and a pet, they could be used by two humans or two pets, or some combination of more than two humans and pets. Particularly, children may recognize the advantages of the elevation pieces and would enjoy sitting next to their parent while their parent sits in the bigger chair. Further, even though all embodiments have depicted the pet seat to the left of the forward facing office chair, the pet seat could also be on the other side of the office chair.

Alternative embodiments may include a lack of barrier or positive structures to allow the pet to move to the human's seat or on the human's lap. This access of engagement by the pet or human help promote positive interaction between the two. The intermediate armrest is an example of a structure that may act as a barrier or invitation to the pet when the intermediate armrest is raised by the human.

In alternative embodiments, the elevation piece in the form of a step or steps may be a solid structure that rotates about a pivot to allow the human and/or pet to engage or disengage the elevation piece.

In alternative embodiments, the human-pet co-seating apparatus may include a chair for a human and a chair for a pet that are part of the same piece of furniture (opposed to being sold as an attachment). These embodiments are particularly useful when the purchaser desires to have a seating apparatus that looks uniform between the human seat and the pet seat.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods, systems, and apparatus described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An attachable standalone pet seating apparatus comprising:
a frame having a front, a back, and two sides;
a pet seat attached to the frame;
an elevation piece attached to the front of the frame and designed to be positioned in an engaged position and a disengaged position by a user to allow a pet to easily access the pet seat at the user's desire, and the elevation piece including a walking surface for the pet to traverse;
a securing mechanism to secure the elevation piece in at least one of the engaged position and disengaged position;
the standalone pet seating apparatus being constructed for the elevation piece to be stored under the pet seat when in the disengaged position; and
wherein the pet seat includes a sidecar attachment mechanism comprising a top attachment means and a bottom attachment means with at least one of the top attachment means and the bottom attachment means having a telescoping shaft.

2. The attachable standalone pet seating apparatus of claim 1, further comprising at least one stability piece attached to the end of a bottom of the elevation piece.

3. The attachable standalone pet seating apparatus of claim 2, further comprising a seat support structure aligned with the sides of the frame and a backpiece aligned with the back of the frame.

4. The attachable standalone pet seating apparatus of claim 3, wherein the pet seat, seat support structure, and backpiece are made of pet-friendly materials.

5. The attachable standalone pet seating apparatus of claim 4, wherein the elevation piece is made to swivel about at least one axis.

6. The attachable standalone pet seating apparatus of claim 5, wherein the elevation piece is a powered version having at least one actuator, a power supply, and a controller.
